(19) United States
(12) Patent Application Publication
(10) Pub. No.: US 2012/0219049 A1
(43) Pub. Date: Aug. 30, 2012

(54) SIGNAL RECEPTION APPARATUS AND SIGNAL RECEPTION METHOD

(75) Inventor: Keigo SOGABE, Oume-shi (JP)

(73) Assignee: KABUSHIKI KAISHA TOSHIBA, Tokyo (JP)

(21) Appl. No.: 13/304,131

(22) Filed: Nov. 23, 2011

(30) Foreign Application Priority Data
Feb. 28, 2011 (JP) 2011-042475

(51) Int. Cl. H04B 17/00

(52) U.S. Cl. 375/224

(57) ABSTRACT

One embodiment provides a signal reception apparatus including: a reception module configured to receive a signal; a storing module configured to store information regarding a characteristic of the received signal; a determination module configured to read out the stored information and to determine a parameter value corresponding to the read-out information; a discrimination module configured to discriminate a noise contained in the signal, based on the signal and the determined parameter value; and an identification module configured to identify the noise contained in the signal, based on a discrimination result by the discrimination module.

### CROSS-REFERENCE TO RELATED APPLICATION(S)

This application claims priority from Japanese Patent Application No. 2011-042475 filed on Feb. 28, 2011, the entire contents of which are incorporated herein by reference.

### FIELD

Embodiments described herein relate generally to a signal reception apparatus and a signal reception method for receiving a signal.

### BACKGROUND

In recent years, information have been communicated between apparatuses through wired or wireless transmission lines of various aspects. As a parameter for evaluating the characteristic of the transmission line, sometimes, the proportion (S/N ratio) between a transmission signal (normal signal) and noise is used. Generally, the S/N ratio is calculated based on the amplitude of the normal signal and the amplitude of the noise contained in a signal passing through the transmission line. It has been tried to enhance the communication reliability in the transmission line in view of the calculated S/N ratio.

Generally, the amplitudes of a normal signal and a noise in a signal are separately measured. For example, the attenuation of the normal signal, the change of a resonance characteristic upon the speed rise of the normal signal, or the crosstalk between transmission lines, occurs depending on lengths or paths of the transmission line(s). Because of these phenomena, sometimes, the amplitudes of the normal signal and the noise in the signal can not be separately measured.

### BRIEF DESCRIPTION OF DRAWINGS

A general architecture that implements the various features of the present invention will now be described with reference to the drawings. The drawings and the associated descriptions are provided to illustrate embodiments and not to limit the scope of the present invention.

FIG. 1 illustrates a block configuration of an electronic equipment which includes a magnetic disc drive (HDD), as a signal reception apparatus according to an embodiment.

FIG. 2 illustrates a system configuration of an HDC (hard disc controller) consists of modules that execute a process for identifying a noise contained in a received signal.

FIGS. 3A and 3B respectively illustrate practicable examples of threshold values which are utilized in the process for identifying a noise contained in a received signal.

FIG. 4 illustrates a flow chart for explaining an operation to be executed in the HDD according to the embodiment for setting the threshold value that is utilized in the process for identifying a noise contained in a received signal.

### DETAILED DESCRIPTION

In general, one embodiment provides a signal reception apparatus including: a reception module configured to receive a signal; a storing module configured to store information regarding a characteristic of the received signal; a determination module configured to read out the stored information and to determine a parameter value corresponding to the read-out information; a discrimination module configured to discriminate a noise contained in the signal, based on the signal and the determined parameter value; and an identification module configured to identify the noise contained in the signal, based on a discrimination result by the discrimination module.

An embodiment will be described with reference to the drawings.

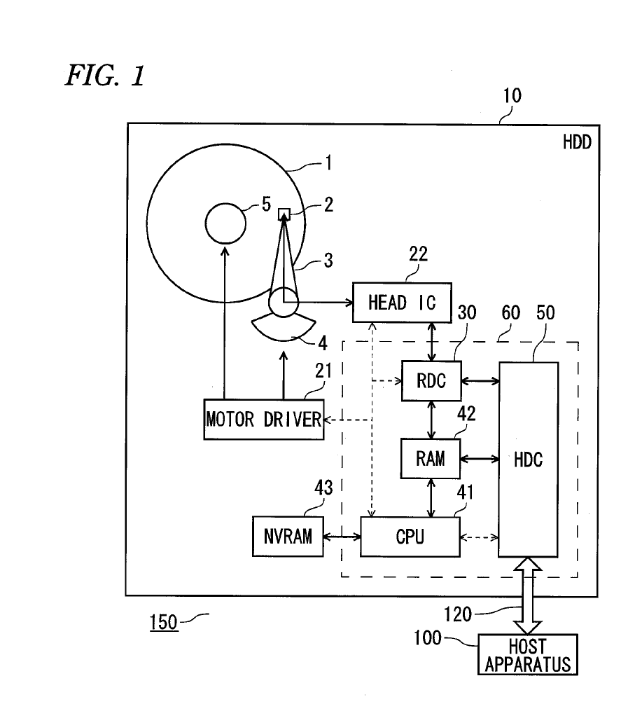

FIG. 1 illustrates a system configuration of an electronic equipment 150 which includes a magnetic disc drive (HDD) 10, as a signal reception apparatus according to the embodiment. The electronic equipment 150 includes a host apparatus 100. The HDD 10 is connected with the host apparatus 100 through a communication medium (host I/F) 120, and it functions as the storage module of the host apparatus 100. The host I/F 120 connects the host apparatus 100 and the HDD 10, and it is utilized for communications, that is, the transmission and reception of information such as data and commands, between the host apparatus 100 and the HDD 10. For example, the electronic equipment 150 is a personal computer, and the host apparatus 100 is a chipset IC in the personal computer. As the signal reception apparatus according to the embodiment, a semiconductor memory device which utilizes an SSD (Solid State Drive) or the like semiconductor memory as a storage medium may also be applied.

The HDD 10 according to the embodiment includes mechanism portions such as a magnetic disc 1, a slider 2, an arm 3, a VCM (Voice Coil Motor) 4 and an SPM (spindle motor) 5. The HDD 10 includes circuit system blocks such as a motor driver 21, a head IC 22, an NVRAM 43 and a controller 60. The controller 60 contains a read/write channel IC (RDC) 31, a CPU 41, a RAM 42 and an HDC (Hard Disc Controller) 50.

In the HDD 10 according to the embodiment, information transmitted from the host apparatus 100 is received as an electric signal. The host I/F 120 is utilized as the transmission line of the signal, and noise sometimes mixes into the signal transmitted through the transmission line. The HDD 10 according to the embodiment identifies the noise contained in the received electric signal, based on signal characteristic information concerning the characteristic of the received signal. That is, the HDD 10 according to the embodiment can appropriately identify the noise contained in the signal received through the transmission line.

The magnetic disc 1 is fixed to the SPM 5 and rotated by the SPM 5. At least one surface of the magnetic disc 1 is a record surface on which information is magnetically recorded. That is, the magnetic disc 1 is a magnetic record medium. Plural tracks being, for example, concentric are defined on the record surface, and each of the tracks has a servo region and a data region. Physical address information of the record surface of the magnetic disc 1 is recorded in the servo region, while a recording-subject information is recorded in the data region.

The slider 2 is disposed at one end of the arm 3 so as to correspond to the record surface of the magnetic disc 1. This slider 2 includes a read head (not shown) and a write head (not shown). The read head reads magnetically-recorded information as a signal from the record surface of the magnetic disc 1. The read signal is outputted to the head IC 22 through a conductor pattern formed on the arm 3. The write head magnetically records information on the record surface of the magnetic disc 1 in accordance with a write signal (write current) which is inputted from the head IC 22 through the conductor pattern on the arm 3.

The arm 3 includes the slider 2 at one end, and a bearing portion (not shown) at the other end. This arm 3 turns about the bearing portion in accordance with a drive current fed to the VCM 4 to thereby move the slider 2 in a radial direction on the record surface of the magnetic disc 1.

The VCM 4 is driven in accordance with the drive signal (current) fed from the motor driver 21 to thereby turn the arm 3.

The SPM 5 is driven in accordance with a drive signal (current) fed from the motor driver 21 to thereby rotate the magnetic disc 1.

The motor driver 21 feeds the drive signal for driving the VCM 4, and the drive signal for driving the SPM 5, based on a control signal from the controller 60 (the CPU 41).

The head IC 22 amplifies a signal which has been inputted from the read head of the slider 2 through the conductor pattern on the arm 3, and it outputs the amplified signal to the controller 60 (the RDC 31) as read information. The head IC 22 outputs a write signal (write current) corresponding to record information inputted from the controller 60 (RDC 31) to the write head of the slider 2 through the conductor pattern on the arm 3.

The controller 60 is configured as a SoC (System On Chip) which includes the RDC 31, the CPU 41, the RAM 42 and the HDC 50. The RAM 42 may not be incorporated in the controller 60, and the RAM 42 provided outside may be connected to the controller 60.

The RDC 31 decodes the read information inputted from the head IC 22 by subjecting this read information to a predetermined process, and it outputs the decoded information to the HDC 50. The RDC 31 encodes recording-subject information inputted from the HDC 50 by subjecting this recording-subject information to a predetermined process, and it outputs the encoded information to the head IC 22 as the record information. And, the RDC 31 detects the servo signal indicating the servo region from the read signal, and it extracts positional information from the detected servo signal. The extracted positional information is outputted to the CPU 41. The RDC 31 utilizes the RAM 42 as a work memory for executing the processes.

The CPU 41 executes a program stored in the NVRAM 43 to thereby control the individual blocks in the HDD 10. This CPU 41 controls plural processes, for example, the rotational control processes of the VCM 4 and the SPM 5, and the information record process for the magnetic disc 1. In the embodiment, the CPU 41 reads out signal characteristic information regarding the characteristic of the electric signal received by the HDC 50. The CPU 41 determines a parameter value corresponding to the read-out signal characteristic information, and it controls a process for setting the determined parameter value for the HDC 50. The CPU 41 controls such that this process is executed at a specified timing during the communications between the HDD 10 and the host apparatus 100. The CPU 41 utilizes the RAM 42 as a work memory for executing such program.

The RAM 42 is the work memory of the RDC 31, the CPU 41 and the HDC 50. A DRAM which is a volatile memory is applied as the RAM 42.

The NVRAM 43 is a nonvolatile memory in which the program to be executed by the CPU 41 is stored. The program stored in the NVRAM 43 can be updated, and the NVRAM 43 stores the parameter values to be utilized in the process executed by the CPU 41.

The HDC 50 executes a communication process for transmitting and receiving information to and from the host apparatus 100. This HDC 50 subjects decoded information inputted from the RDC 31 to a predetermined process to thereby encode the inputted information, and it transmits the encoded information to the host apparatus 100 as transmission information. The HDC 50 subjects received reception information transmitted from the host apparatus 100 to a predetermined process to thereby decode the reception information, and it outputs the decoded information to the RDC 31 as recording-subject information. In the embodiment, the HDC 50 executes a communication process compatible with a given standard such as SATA (Serial Advanced Technology Attachment) standard or SAS (Serial Attached SCSI) standard, between it and the host apparatus 100.

In the embodiment, the HDC 50 receives the reception information transmitted from the host apparatus 100 as an electric signal, and it offers signal characteristic information regarding the characteristic of the received electric signal to the CPU 41. The HDC 50 executes a noise identification process for identifying noise contained in the received electric signal, based on the parameter value set by the CPU 41.

Thus, the communication process for transmitting and receiving the information to and from the host apparatus 100 is executed by the plural blocks in the HDD 10 according to the embodiment. The noise sometimes mixes in the signal which is transmitted through the transmission line 120 utilized for the communications between the HDD 10 and the host apparatus 100. The noise contained in the received electric signal is identified based on the signal characteristic information received by the HDD 10. That is, the HDD 10 according to the embodiment can appropriately identify the noise which is contained in the signal received through the transmission line.

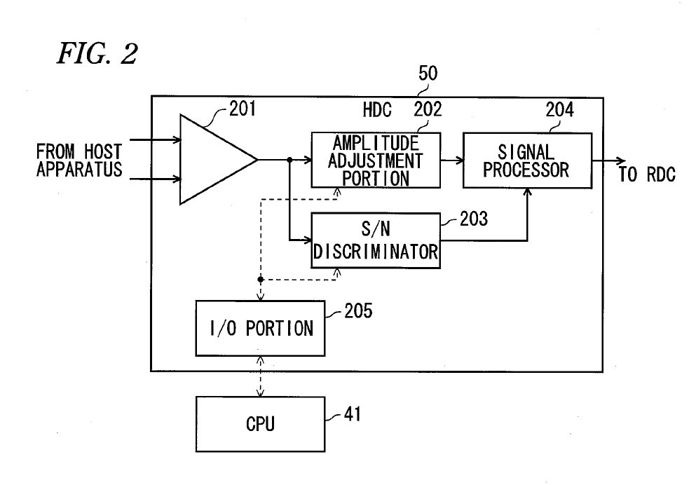

Next, modules in the HDC 50 which execute the noise identification process will be described with reference to FIG. 2.

FIG. 2 illustrates a system configuration of the HDC 50 consists of modules that execute the noise identification process for identifying the noise contained in the received electric signal.

The HDC 50 includes a differential amplifier 201, an amplitude adjustment portion 202, an S/N discriminator 203, a signal processor 204 and an I/O portion 205. The HDC 50 receives differential signals (for example, LVDS) transmitted from the host apparatus 100, and it converts the received differential signals into a single-ended signal. The converted single-ended signal is adjusted to have the amplitude of a predetermined level, and predetermined signal processing is executed for the adjusted signal. The signal subjected to the predetermined signal processing is outputted to the RDC 31. The transmission signal (normal signal) and the noise are discriminated based on the single-ended signal converted from the differential signals.

The differential amplifier 201 receives the differential signals transmitted from the host apparatus 100, and it converts the received differential signals into the single-ended signal. The differential amplifier 201 outputs the converted single-ended signal to the amplitude adjustment portion 202 and the S/N discriminator 203. Further, the differential amplifier 201 converts the received differential signals into the single-ended signal such that a signal obtained by amplifying the difference between the differential signals, predetermined times, is superposed on a predetermined bias signal.

The amplitude adjustment portion 202 subjects the single-ended signal outputted from the differential amplifier 201 to an equalizing process for varying a frequency characteristic, and an amplification process for amplifying or attenuating the resulting signal predetermined times. Owing to these processes, the amplitude adjustment portion 202 outputs a signal having the adjusted frequency characteristic and the adjusted amplitude to the signal processor 204. The amplitude adjustment portion 202 holds the adjustment results of the frequency characteristic and the amplitude based on these processes, and it allows the CPU 41 to read out the held adjustment results as signal characteristic information. In the embodiment, the HDC 50 executes the communication process compatible with the SATA or SAS standard, and hence, the amplitude adjustment portion 202 is configured by FFE (Feed Forward Equalization) or DFE (Decision Feedback Equalization). A Tap coefficient in the DFE of the amplitude adjustment portion 202 is read out as the signal characteristic information by the CPU 41.

The S/N discriminator 203 discriminates the normal signal and the noise based on the single-ended signal outputted from the differential amplifier 201. The discrimination is performed by comparing the single-ended signal with a threshold value. For example, the S/N discriminator 203 discriminates the single-ended signal to be the normal signal when it is greater than the threshold value, and to be the noise when it is less than the threshold value. The threshold value to be utilized for the discrimination is set by the CPU 41. The CPU 41 sets the threshold value based on the signal characteristic information read out from the amplitude adjustment portion 202. As to setting of the threshold value, a table of the signal characteristic information and the threshold value may be previously prepared, or the threshold value may be calculated in accordance with the signal characteristic information. In the embodiment, the HDC 50 executes the communication process compatible with the SATA or SAS standard, and hence, the S/N discriminator 203 is configured of a squelch circuit. The S/N discriminator 203 outputs S/N information which indicates the discrimination result of the normal signal and the noise to the signal processor 204. The S/N information is outputted as binarized information.

The signal processor 204 identifies the normal signal and the noise from the signal having the adjusted frequency characteristic and the adjusted amplitude outputted from the amplitude adjustment portion 202, based on the S/N information outputted from the S/N discriminator 203. The signal processor 204 subjects the identified normal signal to a predetermined process to thereby decode the normal signal, and it outputs the decoded information to the RDC 31 as the recording-subject information.

The I/O portion 205 executes a process concerning the transmission and reception of information between the CPU 41 and the amplitude adjustment portion 202 as well as the S/N discriminator 203. Owing to the process, the CPU 41 reads out the signal characteristic information from the amplitude adjustment portion 202 and sets the threshold value for the S/N discriminator 203.

Thus, the noise identification process is executed mainly by the HDC 50 and the CPU 41. Consequently, the HDD 10 according to the embodiment can appropriately identify the noise which is contained in the signal received through the transmission line.

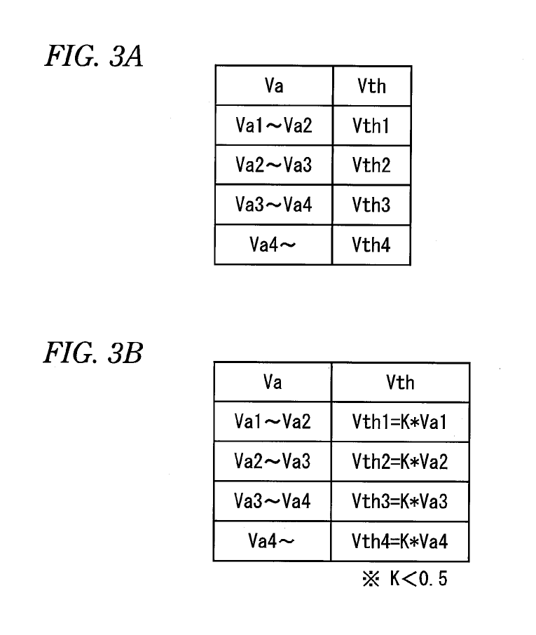

Next, practicable examples of the threshold values which are set for the S/N discriminator 203 by the CPU 41 and which are utilized in the noise identification process will be described with reference to FIGS. 3A and 3B.

FIGS. 3A and 3B respectively illustrate the practicable examples of the threshold values which are utilized in the noise identification process for identifying the noise contained in the received electric signal.

In the example of FIG. 3A, the table in which the signal characteristic information and the threshold values are associated is stored beforehand. In the example of FIG. 3B, the threshold values are calculated in accordance with the signal characteristic information.

In the example of FIG. 3A, the threshold value Vth is previously associated for every range of the amplitude Va of the single-ended signal outputted from the differential amplifier 201. In other words, plural threshold values as parameter candidates are stored beforehand. A threshold value Vth1 is associated with a range in which the amplitude of the single-ended signal is Va1 to Va2, a threshold value Vth2 with a range in which the amplitude of the single-ended signal is Va2 to Va3, a threshold value Vth3 with a range in which the amplitude of the single-ended signal is Va3 to Va4, and a threshold value Vth4 with a range in which the amplitude of the single-ended signal is larger than Va4. In this practicable example, four ranges are defined for the amplitude Va of the single-ended signal, but the division number of ranges is not restricted thereto. For each range, the threshold value is set to be sufficiently smaller than the smallest value within the corresponding range. In a case, for example, where the amplitude of the single-ended signal is in the range of Va1 to Va2, the threshold value Vth1 will be a value smaller than ½ of Va1. The table of this example will be stored in a nonvolatile storage portion (for example, the NVRAM 43).

In the example of FIG. 3B, the threshold value Vth is calculated for every range of the amplitude Va of the single-ended signal outputted from the differential amplifier 201. A threshold value Vth1=K*Va1 is calculated in a range in which the amplitude of the single-ended signal is Va1 to Va2, a threshold value Vth2=K*Va2 is calculated in a range in which the amplitude of the single-ended signal is Va2 to Va3, a threshold value Vth3=K*Va3 is calculated in a range in which the amplitude of the single-ended signal is Va3 to Va4, and a threshold value Vth4=K*Va4 is calculated in a range in which the amplitude of the single-ended signal is larger than Va4. The value K is a value smaller than one. For each range, the threshold value is calculated by multiplying the smallest value in the corresponding range with the value smaller than one. That is, the threshold value in each range is se to be a value which is sufficiently small relative to the smallest value in the corresponding range. For example, the value K is set to be smaller than ½. In this practicable example, four ranges are defined for the amplitude Va of the single-ended signal, but the division number of ranges is not restricted thereto. The constant K of this example will be stored in a nonvolatile storage portion (for example, the NVRAM 43).

In a case where the noise mixes in the signal transmitted through the transmission line, the noise of predetermined level sometimes mixes without depending upon the level of the normal signal. In this case, the noise level relative to the amplitude of the normal signal becomes inconstant. As described with reference to FIGS. 3A and 3B, the threshold value for discriminating the S/N information is set based on the signal characteristic information of the received signal in any of the above-mentioned examples. Consequently, the HDD 10 according to the embodiment can appropriately identify the noise which is contained in the signal received through the transmission line.

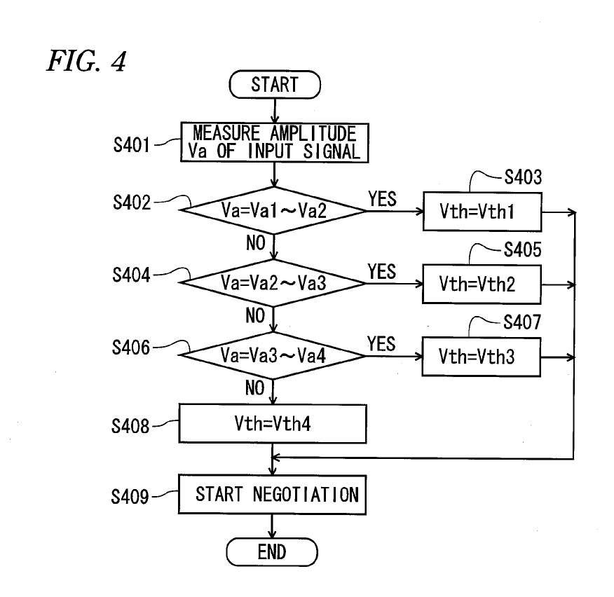

Next, the operation of setting the threshold value which is utilized in the noise identification process will be described with reference to FIG. 4.

FIG. 4 illustrates the operation to be executed in the HDD 10 according to the embodiment for setting the threshold value that is utilized in the noise identification process for identifying the noise contained in the received electric signal.

As stated before, in the embodiment, the HDC 50 executes the communication process compatible with the SATA or SAS standard. In the SATA or SAS standard, a series of command transmission and reception steps, called an “OOB (Out Of Band) sequence”, are executed at the beginning of the communications between the HDD 10 and the host apparatus 100. In the OOB sequence, a master/a slave, a communication protocol, etc. are determined by the mutual outputs of burst patterns. In the embodiment, the operation of setting the threshold value which is utilized in the noise identification process is executed in the operation of the OOB sequence.

When a signal according to the OOB sequence is transmitted from the host apparatus 100 to the HDC 50 in the HDD 10, the measurement of the amplitude Va of the inputted single-ended signal is performed (S401). In a case where the range of the amplitude Va is “Va1 to Va2” (“Yes” at S402), the threshold value Vth is set as Vth1 (S403). In a case where the range of the amplitude Va is not “Va1 to Va2” (“No” at S402) and where the range of the amplitude Va is “Va2 to Va3” (“Yes” at S404), the threshold value Vth is set as Vth2 (S405). In a case where the range of the amplitude Va is not “Va2 to Va3” (“No” at S404) and where the range of the amplitude Va is “Va3 to Va4” (“Yes” at S406), the threshold value Vth is set as Vth3 (S407). And, in a case where the range of the amplitude Va is not “Va3 to Va4” (“No” at S406), the threshold value Vth is set as Vth4 (S408). When the threshold value Vth is set, a negotiation (a negotiation concerning a communication speed) which succeeds to the operation of the OOB sequence is started, irrespective of the range of the measurement result of the amplitude Va of the inputted single-ended signal (S409).

In this way, the operation of setting the threshold value which is utilized in the noise identification process is performed in the HDC 50. The threshold value is set for the HDC 50 from the CPU 41 through the program executed by the CPU 41. Consequently, the HDD 10 according to the embodiment can appropriately identify the noise which is contained in the signal received through the transmission line.

As described above, in accordance with the HDD 10 according to the embodiment, the threshold value for discriminating the S/N information is set based on the signal characteristic information of the received signal by the HDC 50 and the CPU 41 in this HDD 10. In addition, the noise identification process is performed by utilizing the set threshold value. Consequently, the HDD 10 according to the embodiment can appropriately identify the noise which is contained in the signal received through the transmission line.

Although at least one embodiment has been described, the described embodiment has been presented as one example, and the scope of the invention shall not be restricted to this embodiment. The described embodiment is capable of various alterations, modifications, etc. within a scope not changing the purport of the present invention. Further, various inventions can be formed by properly combining plural constituents disclosed in the foregoing embodiment. For example, some constituents may be omitted from all the constituents indicated in the embodiment, and constituents according to different embodiments may be properly combined. These embodiments and the modifications thereof shall be covered within the scope and purport of the invention, and they shall be covered within the invention defined in the claims and a scope equivalent thereto.

1. A signal reception apparatus comprising:
a reception module configured to receive a signal;
a storing module configured to store information regarding a characteristic of the received signal;
a determination module configured to readout the stored information and to determine a parameter value corresponding to the read-out information;
a discrimination module configured to discriminate noise contained in the signal based on the signal and the determined parameter value; and
an identification module configured to identify the noise contained in the signal based on a discrimination result by the discrimination module.

2. The apparatus of claim 1,
wherein the storing module is configured to store information regarding an amplitude of the received signal, and
wherein the determination module is configured to read out the stored information regarding the amplitude of the received signal and to determine a threshold value smaller than the amplitude of the received signal as the parameter value.

3. The apparatus of claim 2,
wherein the determination module is configured to determine a threshold value corresponding to the amplitude for each range of the amplitude of the signal.

4. The apparatus of claim 3,
wherein the determination module is configured to determine a threshold value corresponding to the amplitude from among a plurality of previously-stored threshold values which are associated with each range of the amplitude of the signal.

5. The apparatus of claim 3,
wherein the determination module is configured to determine a threshold value which is calculated for each range of the amplitude of the signal using a previously-stored coefficient.

6. A signal reception method comprising:
receiving a signal by a signal reception apparatus;
storing information regarding a characteristic of the received signal;
reading out the stored information, and determining a parameter value corresponding to the read-out information;
discriminating noise contained in the signal based on the signal and the determined parameter value; and
identifying the noise contained in the signal based on a discrimination result.

7. The method of claim 6,
wherein information regarding an amplitude of the received signal is stored as the characteristic, and
wherein a threshold value smaller than the amplitude of the received signal is determined as the parameter value.

8. The method of claim 7,
wherein a threshold value corresponding to the amplitude is determined for each range of the amplitude of the signal.

9. The method of claim 8,
wherein a threshold value corresponding to the amplitude is determined from among a plurality of previously-stored threshold values which are associated with each range of the amplitude of the signal.

10. The method of claim 8,
wherein a threshold value which is calculated for each range of the amplitude of the signal is determined using a previously-stored coefficient.
